(19) United States
(12) Patent Application Publication
(10) Pub. No.: US 2021/0332745 A1
(43) Pub. Date: Oct. 28, 2021

(54) AIR COMPRESSOR

(71) Applicant: Hsun-Ching Lee, Taichung City (TW)

(72) Inventor: Hsun-Ching Lee, Taichung City (TW)

(21) Appl. No.: 16/857,193

(22) Filed: Apr. 24, 2020

(51) Int. Cl. F02B 63/06; F04B 35/00

(52) U.S. Cl. CPC F02B 63/06; F04B 35/002

(57) ABSTRACT

An air compressor includes a driving device and a vehicle engine. The vehicle engine includes a casing with multiple cylinders and a crank located therein. Each of the cylinders has a piston movably received therein, and each piston has a piston rod which is pivotably connected to the crank. The driving device drives the crank. A cylinder head is mounted to the casing and includes an entrance and an exit. Each of the pistons is moved back-and-forth in the cylinder corresponding thereto by rotation of the crank. Air is sucked into the cylinders via the entrance and is compressed by the pistons. The compressed air is released via the exit.

### BACKGROUND OF THE INVENTION

### 1. Fields of the Invention

The present invention relates to an air compressor, and more particularly, to an air compressor that uses a driving device to activate the cylinders in a vehicle engine to compress air.

### 2. Descriptions of Related Art

There are multiple types of air compressors which are reciprocating air compressors, rotary screw compressors, axial compressors and centrifugal compressors. Different types of the air compressors have different structure and outputs, and the prices are vary. The users may choose a specific type of air compressors to meet their needs.

The present invention intends to provide an air compressor which uses a driving device to drive a vehicle engine, and the air is compressed by the operation of the pistons of the vehicle engine.

### SUMMARY OF THE INVENTION

The present invention relates to an air compressor and comprises a driving device and a vehicle engine. The vehicle engine includes a casing, a crank, multiple cylinders and multiple pistons. The cylinders are located in the casing, and each of the cylinders has a piston movably received therein. Each piston has a piston rod and the crank is pivotably connected to the piston rods. The driving device rotates the crank to activate the pistons. A cylinder head is mounted to the casing and includes an entrance and an exit. Each of the pistons is moved back-and-forth in the cylinder corresponding thereto by rotation of the crank. Air is sucked into the cylinders via the entrance and is compressed by the pistons and released via the exit.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 illustrates the air compressor of the present invention;

FIG. 2 is a cross sectional view to illustrate the air compressor of the present invention;

FIG. 3 illustrates that the air compressor of the present invention is cooperated with an air container and a belt;

FIG. 4 is a partial cross sectional view of the air compressor in FIG. 3, cooperated with an air container and a belt;

FIG. 5 is a partial cross sectional view of the air compressor in FIG. 3, cooperated with a supercharger, an air container and a belt;

FIG. 6 is a partial cross sectional view of the air compressor in FIG. 3, cooperated with a heat pump, a supercharger, an air container and a belt, and

FIG. 7 is a second embodiment of the air compressor in FIG. 6.

### DETAILED DESCRIPTION OF THE PREFERRED EMBODIMENT

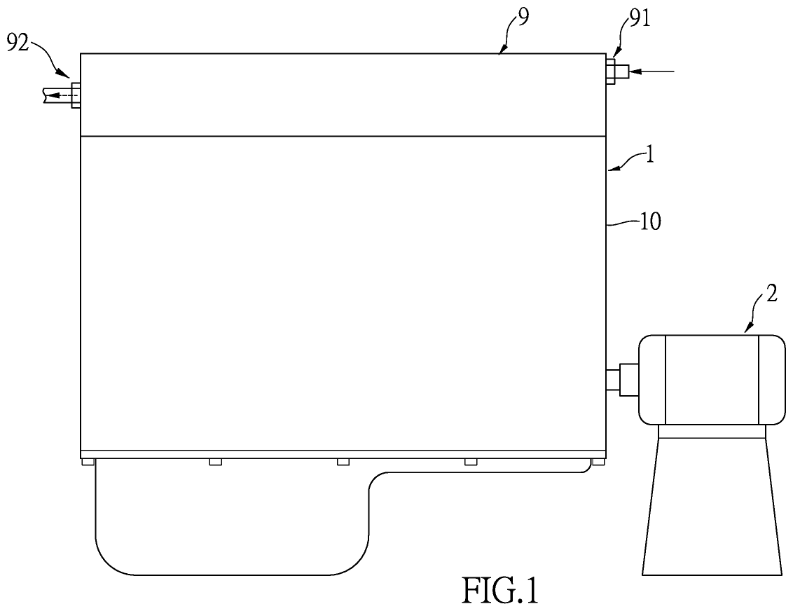

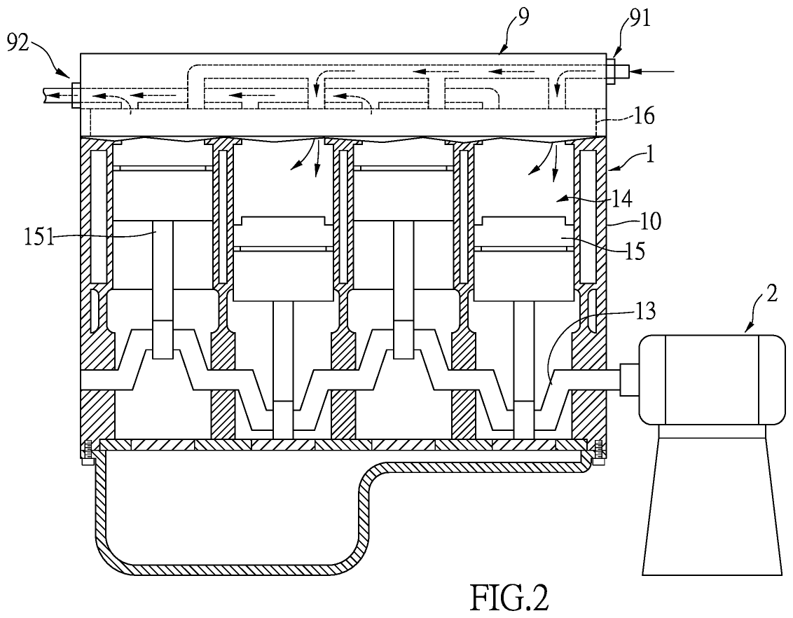

Referring to FIGS. 1 and 2, the air compressor of the present invention comprises a driving device 2 and a vehicle engine 1. Of course, any engine system can be used. The vehicle engine 1 includes a casing 10, a crank 13, multiple cylinders 14 and multiple pistons 15. The cylinders 14 are located in the casing 10, and each of the cylinders 14 has a piston 15 movably received therein. Each piston 15 includes a piston rod, and the crank 13 is pivotably connected to the piston rods. The driving device is connected to the first end of the crank 13 so as to rotate the crank 13. A cylinder head 9 is mounted to the casing 10 and includes an entrance 91 and an exit 92. Each of the pistons 15 is moved back-and-forth in the cylinder 14 corresponding thereto by rotation of the crank 13. The air is sucked into the cylinders 14 via the entrance 91 and compressed by the pistons 15 and released via the exit 92. The vehicle engine 1 can be obtained from a used car by a limited cost. Each cylinder 14 includes a vale 16 which opens and seals the cylinder 14 to allow the cylinders 14 to properly suck air into the cylinders 14, and to compress the air in the cylinders 14, and to release the compressed air from the exit 92 of the cylinder head 9.

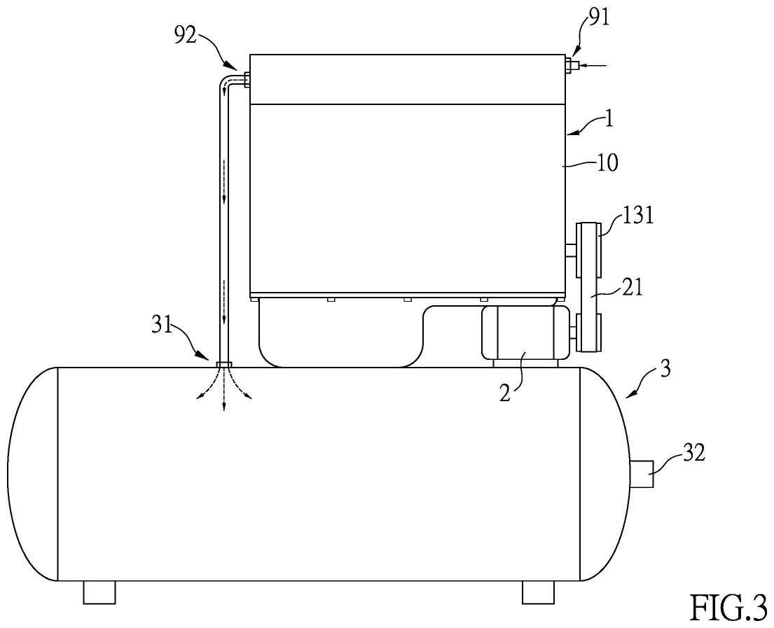

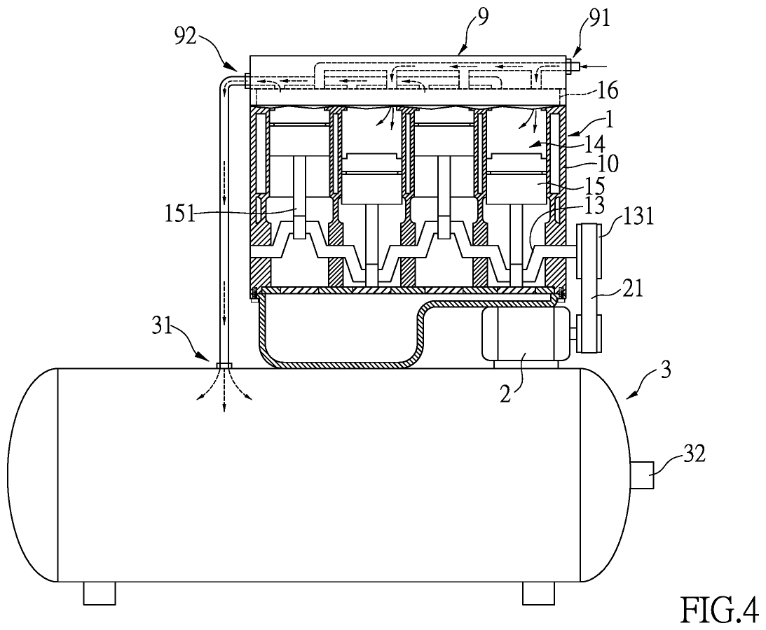

As shown in FIGS. 3 and 4, the driving device 2 includes a belt 21 which is connected to the crank 13. Specifically, the first end of the crank 13 extends beyond the casing 10 and co-axially connected to an idle wheel 131. The belt 21 is connected between the idle wheel 131 and another wheel on the output shaft of the driving device 2. The speed of the crank 13 and be set by changing the diameter of the idle wheel 131.

Furthermore, an air container 3 is cooperated with the air compressor and has an air inlet 31 and an air outlet 32. The air outlet 32 of the air container 3 communicates with the exit 92 of the cylinder head 9. The air container 3 accommodates the compressed air that is released from the exit 92 of the cylinder head 9 so as to provide sufficient compressed air when needed.

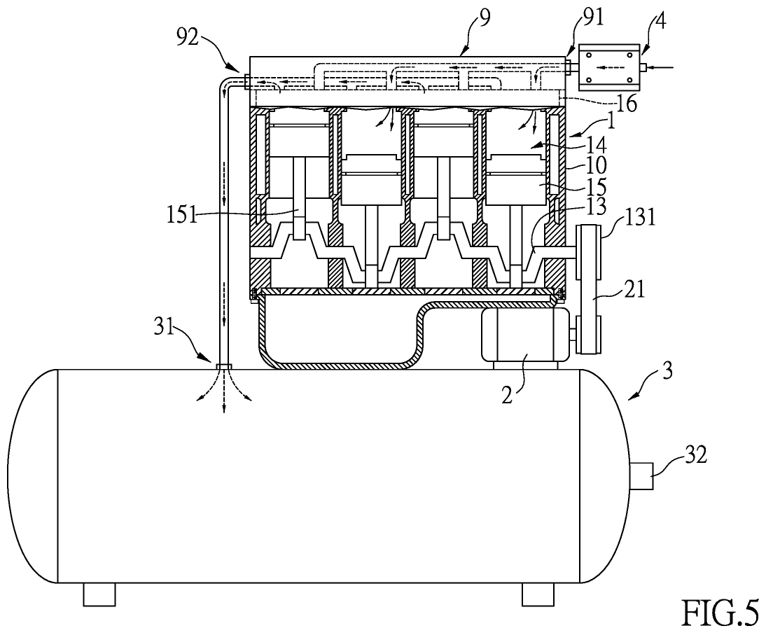

As shown in FIG. 5, the entrance 91 of the cylinder head 9 is connected with a supercharger 4. The supercharger 4 compresses the air before the air is introduced into the entrance 91 of the cylinder head 9 to increase the efficiency of the vehicle engine 1.

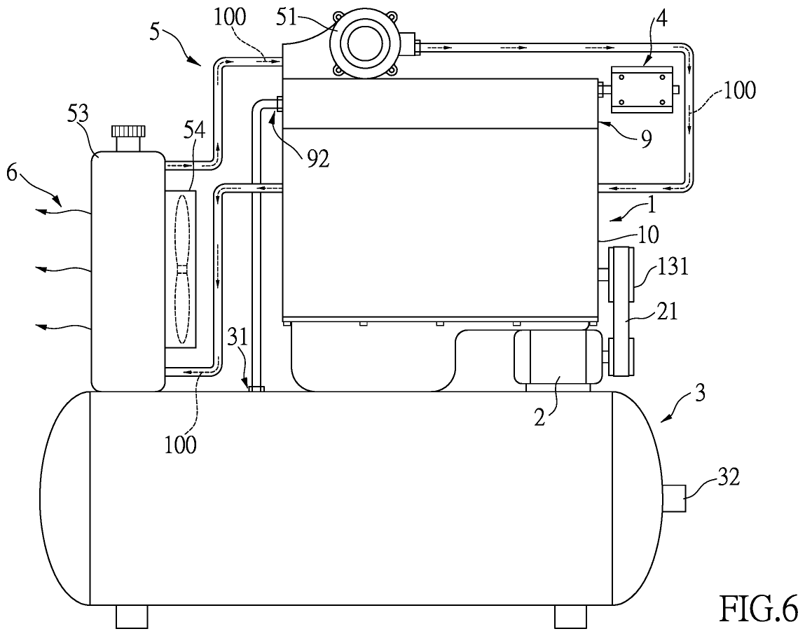

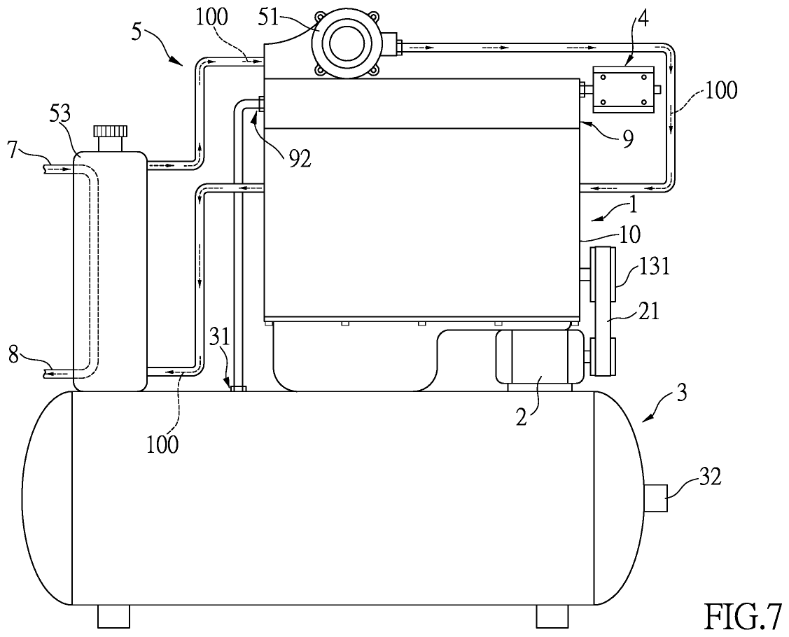

The air compressor of the present invention further comprises a heat pump 5 which includes a water circulation pump 51 and a heat dissipation pump 53. A water circulation path is formed between the water circulation pump 51, the heat dissipation pump 53 and the vehicle engine 1. The heat dissipation pump 53 releases heat which is a heat source of the peat pump 5. As shown in FIG. 6, when the water circulation pump 51 is activated, the water 100 in the heat dissipation device 53 is sucked to the vehicle engine 1 to remove heat from the vehicle engine 1. The water 100 in the vehicle engine 1 flows into the heat dissipation device 53 to absorb heat so as to complete a circulation. The heat dissipation device 53 includes a fan 54 which blows the warm air 6 which is used as the heat source of the heat pump 5 to warn the air. FIG. 7 shows another heat pump 5, wherein the difference from the previous embodiment is the way for dissipating the head. This embodiment uses cooling water 7 to pass through the heat dissipation device 53 to exchange heat with the water 100 in the heat dissipation device 53, so as to obtain hot water 8 which is the heat source of the heat pump 5.

While we have shown and described the embodiment in accordance with the present invention, it should be clear to those skilled in the art that further embodiments may be made without departing from the scope of the present invention.

What is claimed is:

1. An air compressor comprising:
a driving device connected to a vehicle engine;
the vehicle engine including a casing, a crank, multiple cylinders and multiple pistons, the cylinders located in the casing, each of the cylinders having a piston movably received therein, each piston having a piston rod and the crank pivotably connected to the piston rods, the driving device connected to a first end of the crank so as to rotate the crank, a cylinder head mounted to the casing and including an entrance and an exit, each of the pistons being moved back-and-forth in the cylinder corresponding thereto by rotation of the crank, air being sucked into the cylinders via the entrance and being compressed by the pistons and released via the exit.

2. The air compressor as claimed in claim 1, wherein the driving device includes a belt which is connected to the crank.

3. The air compressor as claimed in claim 2, wherein the first end of the crank extends beyond the casing and co-axially connected to an idle wheel, the belt is connected between the idle wheel and the driving device.

4. The air compressor as claimed in claim 1 further comprising an air container which has an air inlet and an air outlet, the air outlet of the air container communicates with the exit of the cylinder head.

5. The air compressor as claimed in claim 1, wherein the entrance of the cylinder head is connected with a supercharger.

6. The air compressor as claimed in claim 1 further comprising a heat pump which includes a water circulation pump and a heat dissipation pump, a water circulation path is formed between the water circulation pump, the heat dissipation pump and the vehicle engine, the heat dissipation pump releases heat which is a heat source of the peat pump.
